(19) United States
(12) Patent Application Publication
(10) Pub. No.: US 2006/0244188 A1
(43) Pub. Date: Nov. 2, 2006

(54) Body mount assembly

(76) Inventors: Lawrence W. Johnson, Taylor, MI (US); Brian Parisi, Macomb, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/328,960

(22) Filed: Jan. 10, 2006

Related U.S. Application Data
(60) Provisional application No. 60/675,715, filed on Apr. 28, 2005.

(51) Int. Cl. F16F 1/44

(52) U.S. Cl. 267/293; 267/141

(57) ABSTRACT

A vehicle body mount assembly has first and second retainers defining a core structure having replaceable elastomeric bodies thereon. A mounting plate is provided between elastomeric bodies for securing the assembly to a vehicle frame. A retaining clip is provided to assist in holding the assembly in the frame while fasteners are affixed to the frame.

### CROSS-REFERENCE TO RELATED APPLICATIONS

The present regular United States Patent Application claims the benefits of U.S. Provisional Application Ser. No. 60/675,715 filed Apr. 28, 2005.

### FIELD OF THE INVENTION

The present invention relates generally to body mount assemblies commonly found in motor vehicles for interconnecting the vehicle body and the vehicle frame.

### BACKGROUND OF THE INVENTION

Body mounts are used to fasten a vehicle body to a vehicle frame. Body mounts provide vibration and noise isolation and contribute to improved vehicle ride and handling characteristics. Body mounts are known to include an elongated member extending between mounting holes in the vehicle frame and vehicle body, with an elastomeric element or elements disposed on the elongated member between the vehicle frame and vehicle body.

In a known body mount assembly, rubber bodies are provided on opposite sides of a flange. A bolt extends through the rubber bodies and flange, with washers being provided between the head of the bolt and the first rubber body at one end and between the rubber bodies and the nut at the opposite end of the bolt. For installation, the threaded end of the bolt and the rubber body or bodies on one side of the flange are passed through a hole in the frame from beneath the frame. Studs extending from the flange outwardly of the rubber bodies are inserted through bolt holes in the frame. A mounting plate is passed over the threaded end of the bolt, the rubber body or bodies that were passed through the frame and over the ends of the studs extending through the frame. Nuts are then run onto the studs and eventually tightened to a specified torque to secure the body mount assembly with the flange on one side of the frame and the mounting plate on the opposite side of the frame. The vehicle body is mounted against the rubber bodies passed through the frame and secured by the nut on the end of the bolt extending through the rubber bodies.

Mounting the assembly just described is awkward and time consuming. The assembly is inserted from beneath the frame and must be held in place while the mounting plate is installed from above the frame and until the nuts are run onto the studs. If not held in position the assembly will fall out of the frame. Accordingly, the installer can use only one had to manipulate the mounting plate and nuts, as the other hand is required for holding the assembly in the proper position.

What is needed is a body mount assembly that can be installed more easily and more quickly than known body mount assemblies.

### SUMMARY OF THE INVENTION

The present invention provides a vehicle body mount assembly that is held in position on the frame prior to final attachment with the fasteners, and that uses replaceable rubber bodies to provide different handling and ride characteristics after installation.

In one aspect thereof, the present invention provides a vehicle body mount assembly with a mounting plate having a central opening, and elastomeric bodies on opposite sides of the mounting plate, each the body having a center opening aligned with the center opening of the mounting plate. First and second retainers are provided on opposite sides of the elastomeric bodies. A first tube segment from the first retainer and a second tube segment from the second retainer each extend through some of the elastomeric bodies toward one another. The first and second retainers engage at least some of the elastomeric bodies and restrain the engaged elastomeric bodies against relative rotation. Fastener fixtures are provided on the mounting plate outwardly of the elastomeric bodies.

In another aspect thereof, the present invention provides a vehicle body mount assembly with an elongated mounting plate having a central opening and mounting fixtures outwardly of the central opening; elastomeric bodies on opposite sides of the mounting plate. First and second retainers are on opposite sides of the elastomeric bodies. The first and second retainers have first and second tube segments extending into at least some of the elastomeric bodies. The retainers are configured for engaging adjacent ones of the elastomeric bodies to restrict relative rotation therebetween.

In a further aspect thereof, the present invention provides a vehicle body mount assembly with an elongated mounting plate having a central opening and mounting fixtures outwardly of the central opening. A first group of elastomeric bodies are provided on one side of the mounting plate, and a second group of elastomeric bodies are provided on an opposite side of the mounting plate from the first group of elastomeric bodies. A first retainer has a plate thereof outwardly of the first group of elastomeric bodies, and a second retainer has a plate outwardly of the second group of elastomeric bodies. The first and second retainers have first and second tube segments extending into the first and second groups of elastomeric bodies and the mounting plate. The first and second tube segments are received telescopically and are configured with at least one substantially flat outer face for engaging the elastomeric bodies so as to restrict relative rotation therebetween.

An advantage of the present invention is providing a vehicle body mount assembly that can be mounted easily and quickly and that will stay properly located before fasteners are tightened in place.

Another advantage of the present invention is providing a vehicle body mount assembly having modular elastomeric members, thereby increasing the versatility of the assembly for use on different types of vehicles with different ride and handling requirements.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a vehicle body mount assembly in accordance with the present invention;

FIG. 2 is an exploded view of the vehicle body mount assembly shown in FIG. 1;

FIG. 3 is a cross-sectional view of the vehicle body mount assembly shown in FIG. 1;

FIG. 4 is a perspective view of an elastomeric member in the vehicle body mount assembly;

FIG. 5 is a perspective view of another embodiment of a vehicle body mount assembly in accordance with the present invention;

FIG. 6 is an exploded view of the vehicle body mount assembly embodiment shown in FIG. 5;

FIG. 7 is a cross-sectional view of the vehicle body mount assembly shown in FIG. 5;

FIG. 8 is a perspective view of another embodiment of a vehicle body mount assembly in accordance with the present invention;

FIG. 9 is a perspective view of an upper retainer for the embodiments shown in FIGS. 5 and 8;

FIG. 10 is a perspective view of yet another elastomeric member for a vehicle body mount assemblies of the present invention; and

FIG. 11 is a perspective view of a retaining clip for vehicle body mount assemblies of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

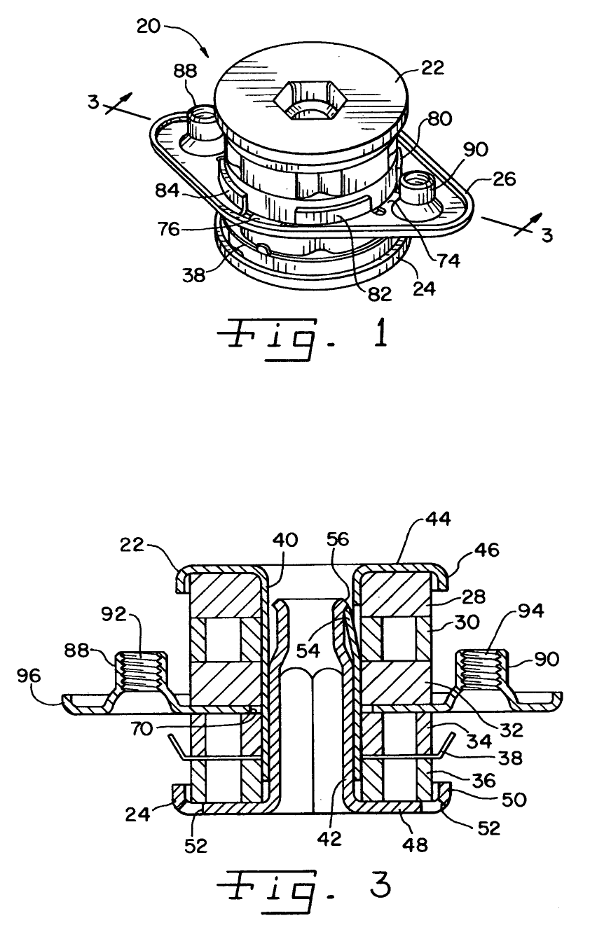

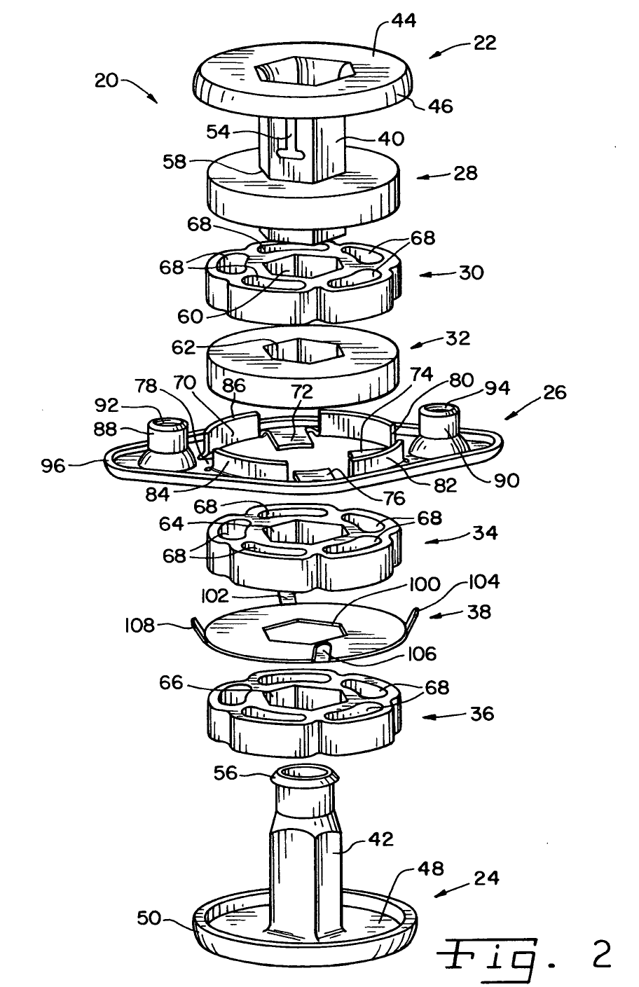

Referring now more specifically to the drawings and to FIGS. 1 and 2 in particular, a vehicle body mount assembly 20 in accordance with the present invention is shown. Body mount assembly 20 includes a first retainer 22 and a second retainer 24 on opposite ends thereof. A mounting plate 26 is disposed between first retainer 22 and second retainer 24. In the exemplary embodiment, three elastomeric bodies 28, 30 and 32 are provided between first retainer 22 and mounting plate 26. In the exemplary embodiment shown, two elastomeric bodies 34, 36 are provided between mounting plate 26 and second retainer 24. A retaining clip 38 is provided between elastomeric bodies 34 and 36.

First retainer 22 and second retainer 24 are metallic bodies that provide structural integrity for assembly 20 and include telescoping tube segments 40 and 42, respectively. As can be seen in the cross-sectional view of the completed assembly shown in FIG. 3, tube segment 40 of first retainer 22 slides over tube segment 42 of second retainer 24. Tube segments 40, 42 define an axial opening through assembly 20 for mounting a vehicle body to the assembly, as will be described more fully hereinafter.

First retainer 22 and second retainer 24 also provide stabilizing structure for elastomeric bodies 28, 30, 32, 34 and 36. Accordingly, first retainer 22 includes a plate portion 44 and a peripheral rim 46 for receiving elastomeric body 28. Second retainer 24 includes a plate portion 48 and a peripheral rim 50 for receiving elastomeric body 36. Rims 46 and 50 provide strength and rigidity to first retainer 22 and second retainer 24, respectively, as well as cupping edges of elastomeric bodies 28 and 36, respectively to stabilize the position of the elastomeric bodies against the retainers.

One or more weep hole 52 (FIG. 3) is provided in second retainer 24, at the bottom of assembly 20, to provide a path to drain moisture or other contaminants away from elastomeric bodies 28, 30, 32, 34 and 36.

To secure the assembly of first retainer 22, second retainer 24, mounting plate 26, elastomeric bodies 28, 30, 32, 34, 36 and retaining clip 38 an inwardly projecting locking arm 54 is provided in tube segment 40. As the distal end of tube segment 42 slides past locking arm 54, the locking arm yields outwardly. A ridge 56 on the distal end of tube segment 42 flares outwardly and engages the end of locking arm 54, as shown in FIG. 3. Accordingly, assembly 20 is secured together by the locking engagement of tube segment 42 within tube segment 40.

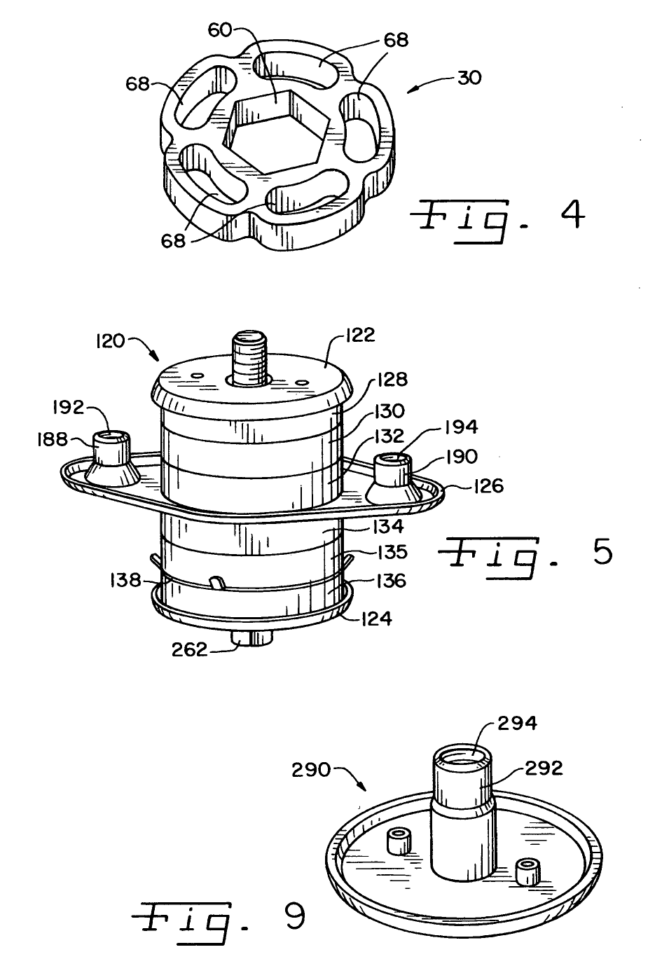

Tube segments 40 and 42 are non-cylindrical, having flat faces extending axially along the length thereof. In the exemplary embodiment tube segments 40, 42 have six-sided shapes. Accordingly, with tube segment 42 inserted in tube segment 40, relative rotation between first retainer 22 and second retainer 24 is limited. Further, as can be seen most clearly in FIGS. 2 and 4, elastomeric bodies 28, 30, 32, 34 and 36 define center openings 58, 60, 62, 64 and 66, respectively, that are also of hexagonal shape to fit on the outer surface of tube segment 40 without rotating thereon. Accordingly, relative rotation between any and all of first retainer 22, second retainer 24 and elastomeric bodies 28, 30, 32, 34 and 36 is restrained by the hexagonal shapes of the interconnected components. It should be understood that shapes other than hexagonal shapes can be used to limit relative rotation between the parts.

Elastomeric bodies 28, 30, 32, 34 and 36 can be provided in various combinations, different numbers and made of different elastomeric material including natural and synthetic rubbers. The selection of material can be used to provide desired stiffness and achieve different ride and handling characteristics in a vehicle. Further, bodies 28, 30, 32, 34 and 36 can be shaped as required to provide different spring and damping characteristics by providing holes therein of different size and shape. FIG. 4 illustrates elastomeric body 30 having a generally lobe-shaped periphery, with elongated holes or void areas 68 of one size and shape in each lobe area; however, holes or void areas of different sizes and shapes, holes or void areas in different numbers or arrangements, or no holes in the elastomeric body can be used. More or fewer elastomeric bodies than the five elastomeric bodies shown in the exemplary embodiments can be used, and the bodies can have shapes other than the somewhat lobed outer periphery shown. Different types of elastomeric bodies can be used in a single assembly, if desired.

Mounting plate 26 is an elongated metallic structure for securing assembly 20 in a vehicle. Mounting plate 26 defines a central opening 70 having inwardly extending feet 72, 74, 76 and 78 for supporting elastomeric body 32 on one side thereof and elastomeric body 34 on the other side thereof. Flanges 80, 82, 84, 86 are provided at the edge of center hole 70, extending along at least a portion of elastomeric body 32, providing lateral support of elastomeric body 32 for added integrity of vehicle body mount assembly 20 when force is exerted fore and aft and to withstand cross-vehicle stresses. It should be understood that more or fewer feet and more or fewer flanges can be used.

In the exemplary embodiment, fastener fixtures in the manner of mounting bosses 88, 90 are provided on opposite ends of mounting plate 26 by which assembly 20 is secured to a vehicle frame. Accordingly, mounting bosses 88 and 90 have internal threads 92, 94, respectively, for engaging a bolt as will be described hereinafter. A peripheral rim 96 is provided at the outer edge of mounting plate 26 to provide further lateral stiffness for assembly 20.

Retaining clip 38, seen most clearly in the enlarged view of FIG. 11, is a metallic plate-like body defining a central opening 100. A plurality of tabs 102, 104, 106, 108 are positioned at the periphery of retaining clip 38 and extend outwardly of the elastomeric bodies on opposite sides of retaining clip 38. More tabs or fewer tabs than the four tabs shown in the exemplary embodiments can be used for the purposes to be described hereinafter.

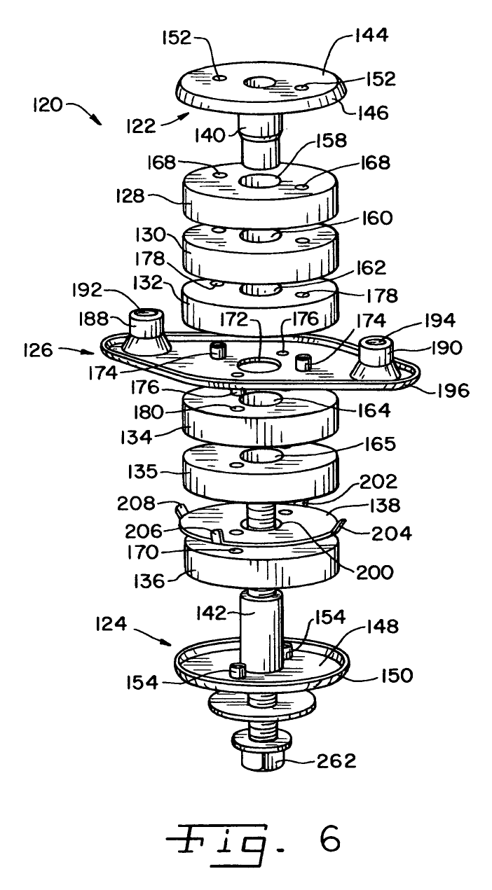

Referring now to FIGS. 5 and 6, a second embodiment of a vehicle body mount assembly 120 in accordance with the present invention is shown.

Assembly 120 includes a first retainer 122 and a second retainer 124 with a mounting plate 126 disposed therebetween. Elastomeric bodies 128, 130, 132 are provided between first retainer 122 and mounting plate 126. Elastomeric bodies 134, 135 and 136 are provided between mounting plate 126 and second retainer 124. A retaining plate 138 is provided between elastomeric bodies 135 and 136.

Assembly 120 is similar to assembly 20, but includes an additional elastomeric body, having six elastomeric bodies instead of the five elastomeric bodies shown in assembly 20. Further, tube segments 140 and 142 of first and second retainers 22 and 24, respectively, are generally cylindrical in outer shape. First retainer 22 includes a plate 144 and a rim 146 and second retainer 124 includes a plate 148 and a rim 150. One or more integral pin 152 projects from plate 144 toward elastomeric body 128. The exemplary embodiment shows two such integral pins 152. Similarly, one or more integral pin 154 extends from plate 148 toward elastomeric body 136, two such integral pins 154 being shown in the exemplary embodiment.

Elastomeric bodies 128, 130, 132, 134, 135 and 136 define substantially circular center openings 158, 160, 162, 164, 165, 166, respectively, for fitting onto tube segments 140 and 142. At least elastomeric bodies 128 and 136 adjacent first retainer 122 and second retainer 124, respectively, are provided with appropriately positioned holes 168, 170 respectively for receiving pins 152, 154, respectively. Depending on the length of pins 152, 154 intermediate elastomeric bodies 130, 132, 134 and/or 135 can also be provided with appropriate holes for receiving the pins.

Mounting plate 126 defines a central opening 172 and one or more integral pin 174 extending therefrom on one side thereof toward adjacent elastomeric body 132, and one or more integral pin 176 extending therefrom on an opposite side thereof toward elastomeric body 134. Pins 174 and 176 on opposite surfaces of mounting plate 126 can be aligned with each other or askew from each other and aligned with or askew from one or both of pins 152 and 154. Elastomeric body is 132, 134 on opposite sides of mounting plate 126 are provided with appropriately sized and a located holes 178, 180, respectively, to receive pins 174, 176. It should be noted that pins 152, 154, 174 and 176 can be similarly sized and positioned so that the appropriate holes 168, 170, 178, 180 can also be of similar size and location, and all elastomeric members are interchangeable for any position in assembly 120. Pins 152, 154, 174 and 176 within holes 168, 170, 178, 180 restrain the elastomeric bodies against relative rotation. As noted previously, pins 152, 154, 174 and 176 can be of sufficient length to extend through several of the elastomeric bodies, so that all elastomeric bodies are actively restrained. Alternatively, inner ones of the elastomeric bodies can be restrained from relative rotation by compression and friction between other elastomeric bodies.

Mounting plate 126 is further provided with mounting bosses 188, 190 having internal threads 192, 194, respectively, similar to bosses 88, 90 and threads 92, 94 of assembly 20 described previously. A peripheral rim 196 is provided around mounting plate 126 to provide stiffness.

Retaining clip 138 defines a center hole 200 and peripheral tabs 202, 204, 206 and 208 similar to center opening 100 and tabs 102, 104, 106, 108 in retaining clip 38 described previously.

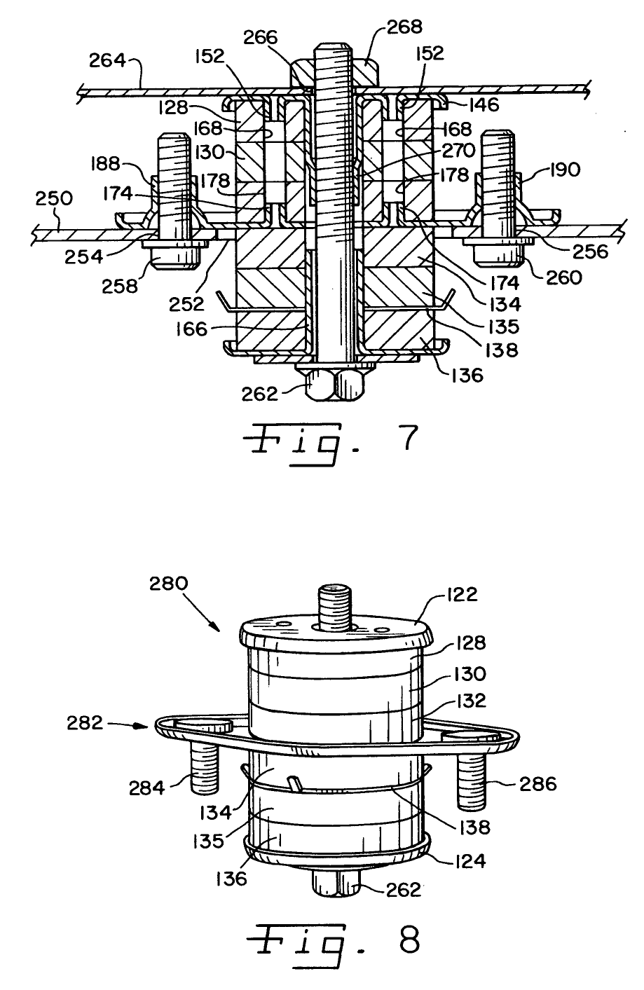

FIG. 7 illustrates the manner in which the aforedescribed embodiments are mounted in a vehicle. FIG. 7 illustrates the installation of assembly 120; however, it should be understood that assembly 20 is mounted in a similar manner. A vehicle frame 250 is provided with an opening 252 for receiving assembly 120 and bolt holes 254, 256 by which assembly 120 is secured to frame 250. Second retainer 124 and elastomeric body 136 are lowered through opening 252. Tabs 202, 204, 206 and 208 of retaining clip 138 define an outer perimeter wider than opening 252. Accordingly, tabs 202, 204, 206 and 208 engage the periphery of opening 252 and are deflected inwardly as force is exerted against assembly 120. Retaining clip 138 “snaps through” opening 252, and tabs 202, 204, 206 and 208 rebound outwardly after passing through opening 252. When retaining clip 138 has passed completely through opening 252, tabs 202, 204, 206 and 208 prevent assembly 120 from being pulled easily outwardly in the direction from which it was inserted. Accordingly, assembly 120 remains in opening 252 during subsequent movement and handling of frame 250.

Assembly 120 is inserted until mounting plate 126 rests on frame 250, with bolt holes 254, 256 aligned with mounting bosses 188, 190. Thereafter, bolts 258, 260 are inserted into holes 254, 256 in frame 250 and are threadedly engaged with threads 192, 194 of bosses 188, 190. Proper torque is applied to bolts 258, 260, and assembly 120 is thereby secured to frame 250.

To connect a vehicle body to frame 50, a bolt 262 is inserted through tube segments 140, 142. A vehicle body 264 defining a hole 266 is placed over the end of bolt 262, and a nut 268 is secured thereto. As shown in FIG. 7, a constriction 270 can be provided in one or both of tube segments 140, 142 to hold bolt 262 in assembly 120 as the vehicle body is placed thereon.

FIG. 8 illustrates a further embodiment of a mount assembly 280 in accordance with the present invention which is similar in many ways to assembly 120 described previously. Components of mount assembly 280 that are similar to components of assembly 120 have been designated with the same reference numerals. In assembly 280, instead of internally threaded bosses 88, 90 or 188, 190, assembly 280 is provided with a mounting plate 282 having fastener fixtures in the manner of staked bolts or studs 284, 286. Studs 284, 286 are passed through holes 254, 256 of frame 250. Once positioned, nuts (not shown) are engaged with studs 284, 286 to secure assembly 280 relative to frame 250. Mount assembly 280 differs further from mount assembly 120 in the location of retaining clip 138. In assembly 120, retaining clip 138 is located between elastomeric bodies 135 and 136. In assembly 280 retaining clip 138 is located between elastomeric bodies 134 and 135. Other than the location thereof, the retaining clips are similar.

FIG. 9 illustrates a further variation of the present invention in which an upper retainer 290 for any of the embodiments described previously herein includes a tube segment 292 with internal threads 294 for threadedly receiving and hold bolt 262 in the assembled assembly. Using upper retainer 290, a vehicle mount assembly can be fully preassembled before attaching to a vehicle frame and subsequent lowering of a vehicle body thereon. A bolt such as bolt 262 inserted through a second retainer and engaged with threads 294 of retainer 290 can be used to draw the retainers together, and the assembly can be preassembled even if tube segment 292 does not engage or even physically meet a tube segment from a second retainer used therewith.

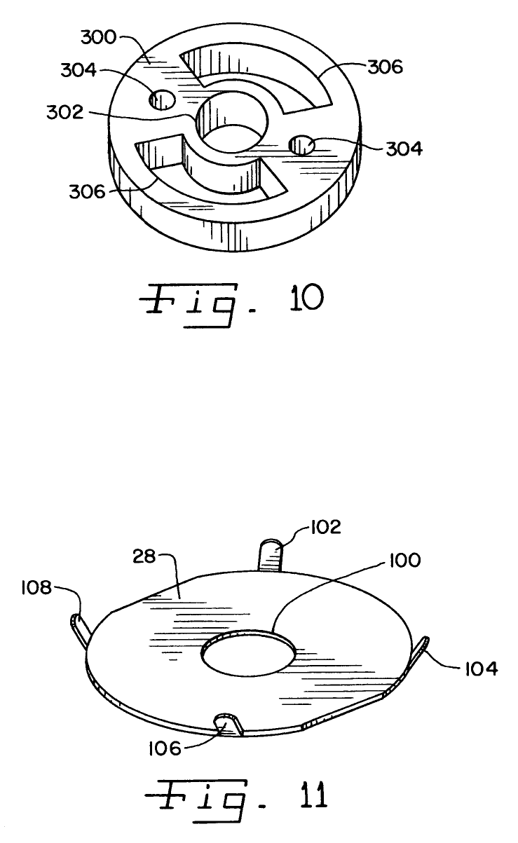

FIG. 10 illustrates an alternate form for a substantially round elastomeric body 300 for use in body mount assemblies of the present invention. Body 300 has a central hole or opening 302 and pin receiving holes 304. One or more void area 306 is provided to adjust performance of the material disk forming body 300. Other shapes, sizes and configurations for elastomeric bodies also can be used. By altering the elastomeric bodies used, vehicle mount assemblies performing differently can be provided using the same first and second retainer, mounting plate, retaining clip and bolts. Accordingly manufacturers need supply fewer different parts for use on vehicles having different requirements for body mount assemblies.

The present invention provides a vehicle body mount assembly that can be preassembled and is easy to install as a single unit. The assembly is adaptable for use on various types of vehicles and includes modular elastomeric members for adjusting performance of the mount assembly.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A vehicle body mount assembly comprising:
a mounting plate having a central opening;
elastomeric bodies on opposite sides of said mounting plate, each said body having a center opening aligned with said center opening of said mounting plate;
first and second retainers on opposite sides of said elastomeric bodies;
a first tube segment from said first retainer and a second tube segment from said second retainer each extending through some of said elastomeric bodies toward one another;
said first and second retainers engaging at least some of said elastomeric bodies and restraining said engaged elastomeric bodies against relative rotation; and
fastener fixtures on said mounting plate outwardly of said elastomeric bodies.

2. The vehicle body mount assembly of claim 1, said tube segments being telescopically engaged one with the other.

3. The vehicle body mount assembly of claim 2, one of said tube segments defining a yieldable locking arm and the other of said tube segments defining a ridge for sliding past and engaging said locking arm.

4. The vehicle body mount assembly of claim 2, said tube segments each having at least one flat axial face, and said center openings of said elastomeric bodies having corresponding flat segments receiving said tube segments.

5. The vehicle body mount assembly of claim 1, said mounting plate defining pins extending into an elastomeric body on opposite sides of said mounting plate.

6. The vehicle body mount assembly of claim 5, said mounting plate having a rim at the periphery thereof.

7. The vehicle body mount assembly of claim 1, said fastener fixtures comprising internally threaded bosses.

8. The vehicle body mount assembly of claim 1, said fastener fixtures comprising threaded studs.

9. The vehicle body mount assembly of claim 1, said first and second retainers each having a plate and a peripheral rim.

10. The vehicle body mount assembly of claim 1, one of said retainers defining a weep hole.

11. The vehicle body mount assembly of claim 1, said retainers each having at least one pin projecting into an adjacent elastomeric body.

12. The vehicle body mount assembly of claim 1, including a retaining clip between tow adjacent said elastomeric bodies, said retaining clip having tabs extending outwardly beyond said adjacent elastomeric bodies.

13. The vehicle body mount assembly of claim 1, said elastomeric bodies being disc-like bodies having holes therethrough outwardly of said center openings thereof.

14. The vehicle body mount assembly of claim 1, one of said tube segments being internally threaded.

15. A vehicle body mount assembly comprising:
an elongated mounting plate having a central opening and mounting fixtures outwardly of said central opening;
elastomeric bodies on opposite sides of said mounting plate, first and second retainers on opposite sides of said elastomeric bodies, said first and second retainers respectively having first and second tube segments extending into at least some of said elastomeric bodies;
said retainers configured for engaging adjacent ones of said elastomeric bodies so as to restrict relative rotation therebetween.

16. The vehicle body mount assembly of claim 15, said first and second tube segments telescopically received one in the other.

17. The vehicle body mount assembly of claim 16, said tubes having at least one flat axial face, and said elastomeric bodies having a central opening configured for receiving said at least one flat axial face.

18. The vehicle body mount assembly of claim 17, said mounting plate including inwardly extending tabs in said central opening thereof and peripheral flanges at an edge of said central opening for positioning elastomeric bodies on at least one side thereof.

19. The vehicle body mount assembly of claim 15, including a retaining clip disposed between two of said elastomeric bodies, said retaining clip having tabs projecting outwardly beyond said elastomeric bodies.

20. The vehicle body mount assembly of claim 15, said mounting fixtures being internally threaded bosses.

21. The vehicle body mount assembly of claim 15, said mounting fixtures being externally threaded studs.

22. A vehicle body mount assembly comprising:
an elongated mounting plate having a central opening and mounting fixtures outwardly of said central opening;
a first group of elastomeric bodies on one side of said mounting plate;
a second group of elastomeric bodies on an opposite side of said mounting plate from said first group of elastomeric bodies;
a first retainer having a plate thereof outwardly of said first group of elastomeric bodies;
a second retainer having an other plate outwardly of said second group of elastomeric bodies;
said first and second retainers respectively having first and second tube segments extending into said first and second groups of elastomeric bodies and said mounting plate, said first and second tube segments telescopically received one in another;
said tube segments configured with at least one substantially flat outer face for engaging said elastomeric bodies so as to restrict relative rotation therebetween.

23. The vehicle body mount assembly of claim 22, said plates of said retainers and said mounting plate having peripheral rims.

24. The vehicle body mount assembly of claim 22, said mounting plate having flanges adjacent said central opening, said flanges extending along an adjacent one of said elastomeric bodies.

25. The vehicle body mount assembly of claim 22, including a retaining clip disposed between two of said elastomeric bodies, said retaining clip having tabs projecting outwardly beyond said elastomeric bodies.

26. The vehicle body mount assembly of claim 22, said second tube segment being telescopically received in said first tube segment, and said first tube segment having a deflectable locking arm engaging an end of said second tube segment.
